(19) United States
(12) Patent Application Publication
(10) Pub. No.: US 2010/0140920 A1
(43) Pub. Date: Jun. 10, 2010

(54) Pipe joint including a pipe and method for producing a joint section of a pipe joint

(76) Inventors: Alexander Kloss, Köln (DE); Alfons Schorn-Gilson, Swisttal-Odendorf (DE)

Correspondence Address: Friedrich Von Rohrscheidt, 7400 Whitepine Road, Richmond, VA, 23237, US

(21) Appl. No.: 12/590,459

(22) Filed: Nov. 6, 2009

(30) Foreign Application Priority Data
Nov. 6, 2008 (DE) DE 102008043502.3

(51) Int. Cl. F16L 19/00; F16L 19/03; B23P 11/00

(52) U.S. Cl. 285/24; 29/428

(57) ABSTRACT

The invention relates to a pipe joint (1) or to a method for producing the pipe joint, comprising a pipe (4), a threaded connecting body (3) and a coupling nut (7). The pipe (4) comprises a non-deformed section (5) in which the pipe (4) is in an original state, and a joint section (6) in which the pipe (4) is configured with a retaining bead (17), which transitions into a 45° retaining cone (18) on one side and transitions into a 24° centering cone (19) on another side, wherein the 45° retaining cone (18) interacts with a 45° clamping cone (14) of the coupling nut (7), and the 24° centering cone (19) interacts with a 24° receiving cone (8) of the threaded connecting body (3) in an operating state of the pipe connection (1).

In order to improve a known pipe joint and a known method for producing the pipe joint, so that it becomes usable in a most flexible manner, it is provided according to the invention that the joint section (6) of the pipe (4) is integrally connected with the non-deformed section (5) of the pipe (4) and produced through a plastic deformation process, in particular a crushing process caused in an axial direction of the pipe (4).

### RELATED APPLICATIONS

This application claims priority from and incorporates by reference German patent application serial No. DE 10 2008 043 502.3, filed on Nov. 6, 2008

### BACKGROUND

1. Field of the Invention

The invention relates to a pipe joint including a pipe according to the preamble of patent claim 1. The invention furthermore relates to a method for producing a joint section of a pipe joint according to the preamble of patent claim 6.

Pipe joints of said type are generally known, wherein the joint section and the regular section of the pipe are typically provided as separate components initially and have to be welded together before joining the pipe joint. The joint section of the pipe is typically a welding cone or a sealing cone, which is machined from solid material, which provides for great freedom for selecting the shape. In particular, the geometry of the enveloping surface on the outside of the welding cone is rather complex due to the configuration of the retaining bead and the centering bead, which is inclined in opposite direction of the retaining bead and which comprises a circumferential groove. A welding cone of this type is standardized in DIN EN ISO 8434-1.

The non-deformed pipe section is typically the pipe itself, to which the welding cone is connected by a weld.

In principle, welded joints have proven themselves in practical applications with respect to strength and service life. It is a disadvantage of this technique that a welded joint is comparatively complex, since the pipe end has to be carefully prepared before the welding process. Furthermore, a welded joint can only be fabricated by specially trained technicians, which increases production cost.

2. Object of the Invention

It is the object of the present invention to improve a pipe joint and a method for producing the pipe joint, so that the pipe joint is universally usable, wherein a welded joint between the joint section and the non-deformed section shall be omitted.

### BRIEF SUMMARY OF THE INVENTION

Based on the described pipe joint, the object is accomplished in that the joint section of the pipe is integrally connected with the non-deformed section of the pipe and produced in particular through a forming process, in particular a crushing process performed at least in axial direction of the pipe.

This way, the joint section and the non-deformed section of the pipe are fabricated as one component, so that a welding process to join them can be omitted and the assembly process of the pipe joint is simplified overall. Furthermore, there are no changes in the microstructure due to high thermal loads proximal to the weld. A leak check can also be omitted.

It is another advantage of the pipe joint according to the invention over known pipe joints, that the forming process of the pipe does not cause any loss of material. Contrary to that, a large amount of waste material in the form of chips is generated when a welding cone is machined from solid material, which eventually causes the production cost for the welding cone to be high.

Different from a machined welding cone, which can have a wall thickness which varies over its length, the wall thickness of the pipe in the formed section according to the invention is also a function of the wall thickness of the pipe in the non-formed section, and can only be varied to a minor extent.

It is advantageous for the circumferential groove to comprise a parallelogram cross section and two walls extending parallel to one another and orthogonal to the longitudinal axis of the pipe and a base of the groove extending parallel to the 24° centering cone, since an O-ring housed therein is retained particularly safely.

When the 24° centering cone extends to the face of the pipe, a particularly short joint section can be produced.

Based on the fabrication of the pipe joint according to the invention through plastic deformation, it will be typically provided depending on the embodiments that the inner enveloping surface of the pipe is provided with a radially outward extending circumferential indentation in the joint section. This means that e.g. forming the pipe into a retaining bead, thus a curvature oriented towards the outer portion of the pipe simultaneously causes a type of groove or indentation in the inner enveloping surface of the pipe.

Advantageously, there is a stop shoulder between the 45° retaining cone and the 24° centering cone, which stop shoulder comprises a radially oriented stop surface facing the 24° centering cone which stop surface connects in the direction towards the 45° retaining cone to a section of the outer enveloping surface of the joint portion with a cylindrical enveloping surface. The stop shoulder is advantageous in particular for mounting the pipe joint. When assembling the pipe joint in which the coupling nut is threaded onto the treaded body, the pipe is moved towards the threaded body until the stop shoulder contacts the radial face of the threaded body. This causes a strong torque increase which is a perceivable indication for a technician that the components of the pipe joint are precisely joined now and the pipe joint is in operating condition and the assembly is completed. Thus, damages through tightening it too strongly are safety avoided.

Advantageously, the forming process for producing the joint section is a multi step crushing process using a plurality of tools which allows for a complex contour of the joint section with protrusions or recesses.

The object of the invention is accomplished through a method according to the preamble of claim 7 by producing the joint section through a forming process from a prior end section of the non deformed section. This implements the advantages of the pipe joint according to the invention.

It is furthermore advantageous when the circumferential groove is fabricated with a parallelogram shaped cross section and comprises two walls extending orthogonal to the longitudinal axis of the pipe and a base of the groove extending in parallel with the 24° centering cone and when the 24° centering cone is configured so it extends to the face of the pipe.

When the joint section is fabricated through a crushing process using a press and associated forming tools, high quality joint sections are created which can be reproduced easily and reliably.

Eventually, it is advantageous when the joint section is produced through a multi stage crushing process, in particular a crushing process with at least 5 consecutive steps, wherein an increasing approximation of a final contour of the joint section is achieved in each step. Thus, joint sections with complex shape and strong contours can be fabricated in this manner.

### BRIEF DESCRIPTION OF THE DRAWINGS

The invention is subsequently described with reference to two preferred embodiments of a pipe joint according to the invention.

FIG. 1 shows a line up illustration of a threaded body, a pipe with joint section and a coupling nut respectively in semi sectional views;

FIG. 2 shows a pipe joint made of components according to FIG. 1 in assembled state (operating condition) in a semi sectional view;

FIG. 3 shows an illustration of the pipe according to FIG. 1 in semi sectional view;

FIG. 4 shows a pipe joint according to FIG. 1 with an alternatively configured joint section;

FIG. 5 shows a pipe joint made of the components according to FIG. 4 in a hand tight preassembled condition (joined condition) in a semi sectional view;

FIG. 6 shows an illustration of the alternative pipe of FIG. 4 in a semi sectional view.

### DETAILED DESCRIPTION OF THE INVENTION

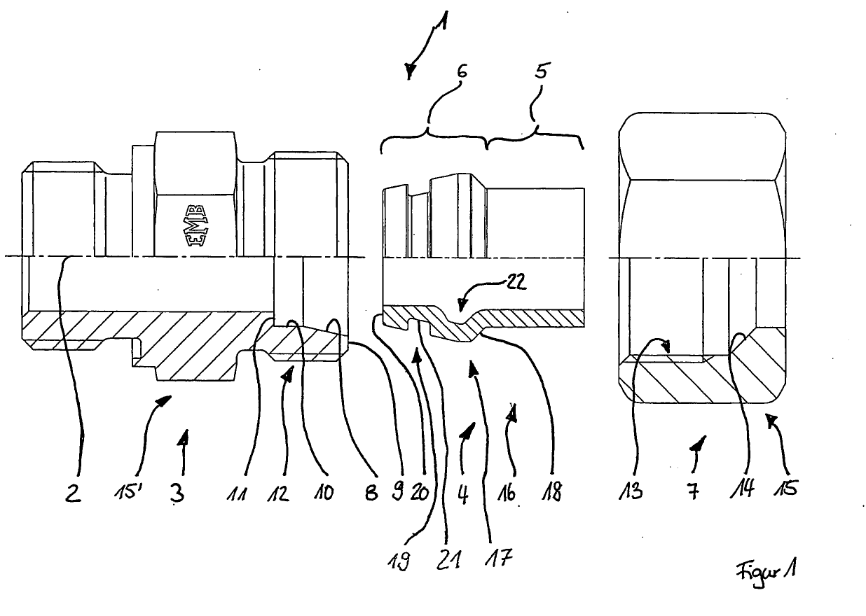

FIG. 1 shows the components of a pipe joint 1 according to the invention which are shown in line next to one another for the purpose of clarity. Starting at the center axis 2 of the components, the lower halves of the components are shown respectively in a sectional view, while the upper halves are shown respectively as a regular view of the components.

The pipe joint 1 is comprised of a threaded body 3, a pipe 4 comprising a non deformed section 5 and a joint section 6 and a coupling nut 7. The threaded body 3 comprises a 24° receiver cone 8 on the side facing the pipe 4, which receiver cone transitions into a radially extending face 9 on the side facing the pipe 4. Towards the side facing away from the pipe 4, the 24° receiver cone 8 transitions into a section 10 which is parallel to the axis, which in turn terminates in a radially extending pipe seat base 11. The threaded body 3 is provided with a threaded section 12 on its outer enveloping surface, which is used for threading the threaded body 3 together with the coupling nut 7. The coupling nut 7 thus comprises a threaded section 13 at its inner enveloping surface. Furthermore, the coupling nut 7 is configured with a 45° clamping cone 14 at its side facing away from the pipe 4. The threaded body 3 and also the coupling nut 7 are provided with a hexagonal surface 15, 15′ for applying a wrench.

Only an end section 16 of the pipe 4 of the pipe joint 1 according to the invention is shown, which end section is comprised of the joint section 6 and a portion of the pipe 4 in its initial state, forming the non deformed section 5. In the joint section 6, the pipe 4 comprises a plastically deformed retaining bead 17, which extends radially outward beyond the outer diameter of the pipe 4 in the non deformed section 6. On the side facing the coupling nut 7, the retaining bead 17 is configured as a 45° retaining cone 18 with which the pipe 4 interacts in assembled state of the pipe joint 1 with the 45° clamping cone 14 of the coupling nut 7.

On the side of the retaining bead 17 which faces the threaded body 3, the retaining bead is configured as a 24° centering cone 19, which is inclined in opposite direction relative to the 45° retaining cone. The 24° retaining cone 19 terminates on the side facing the threaded body 3 in a radially extending face 20. In the portion of the 24° centering cone 19, there is a circumferential groove 21, which is used for receiving and elastomeric seal ring, which is not shown in the figures.

The joint section 6 of the pipe 4 has been fabricated through a multi step forming process of the prior end section 16 of the pipe 4 in its original condition, so that the joint section 6 is integrally connected with the non deformed section of the pipe 4. The pipe 4 and the joint section 6 are thus configured in one piece.

The wall thickness of the pipe 4 in the non deformed section 5 and in the joint section 6 only varies by a comparatively small amount, which is due to the fabrication of the joint section 6 through plastic deformation. When the outer diameter of the pipe 4 expands as it is the case in the portion of the retaining bead 17, the inner diameter of the pipe 4 also increases analogously. Forming a groove on the outer enveloping surface of the pipe 4 causes the formation of a recess 22 or of a hole on the inner enveloping surface.

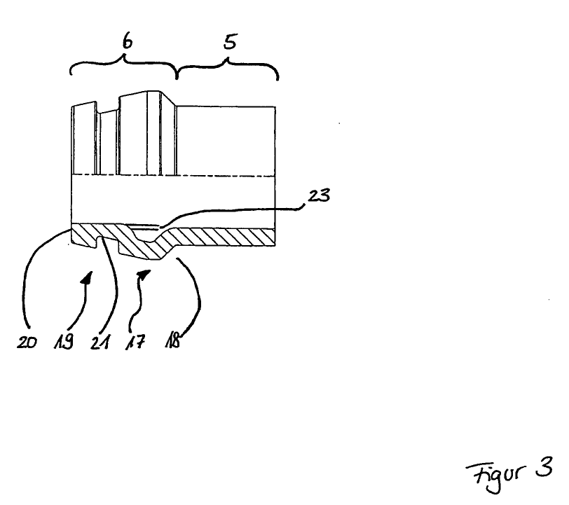

The pipe 4 illustrated in FIG. 1 comprises a larger inner diameter in the portion of the non deformed section 5, than in the portion of the joint section 6, so that a type of step 23 is created, which is shown in FIG. 3.

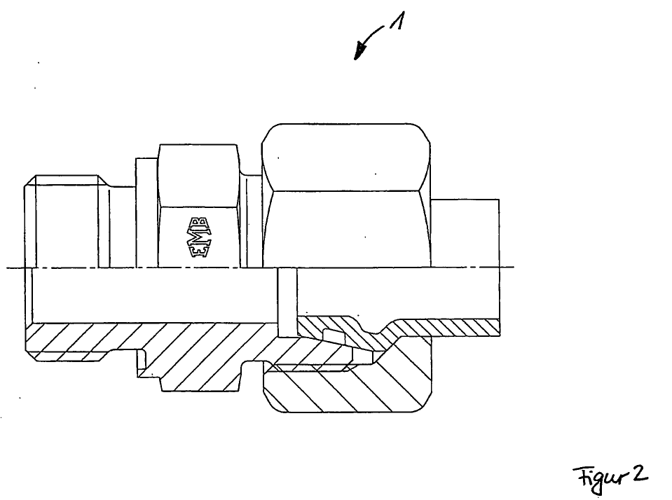

FIG. 2 shows the components of the pipe joint 1 in assembled condition (operating condition). It is already apparent that the 45° retaining cone 18 of the retaining bead 17 interacts with the 45° clamping cone 14 of the coupling nut 7. Furthermore, the 24° centering cone 19 is supported at the 24° receiving cone 8 of the threaded body 3.

FIG. 3 shows again the pipe 4 of the threaded pipe joint according to the invention.

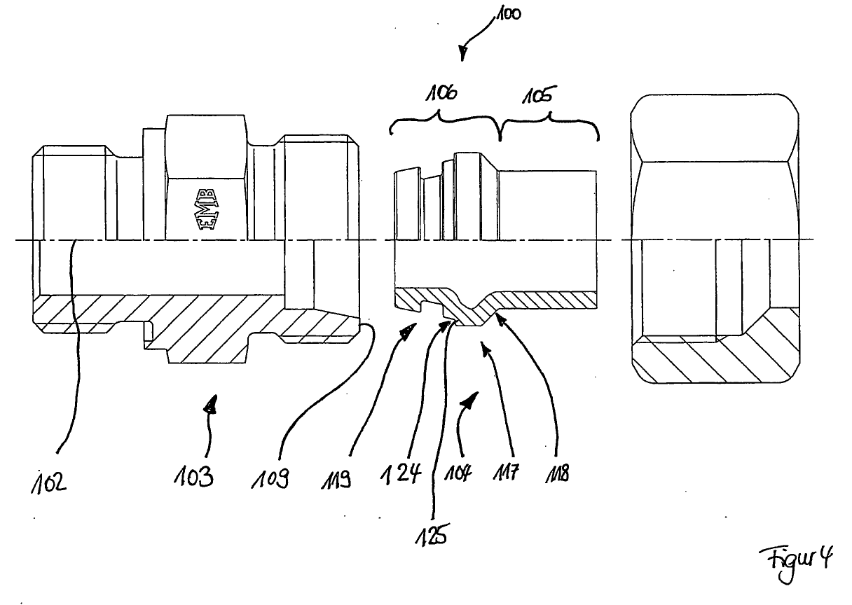

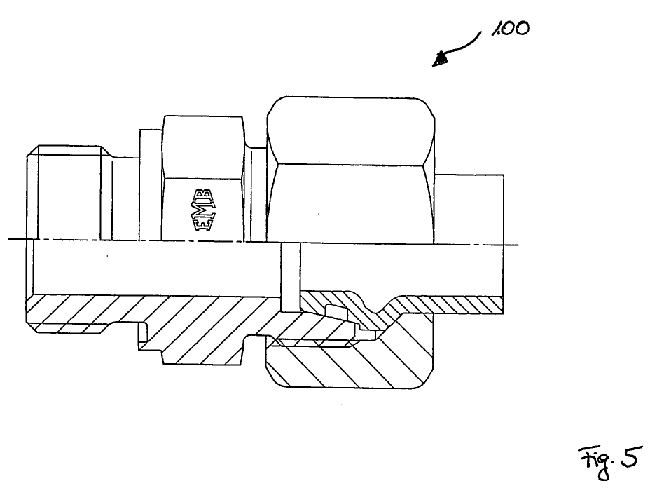

The threaded pipe joint 100 according to FIGS. 4 and 5 corresponds overall to the threaded pipe joint 1 of FIG. 1. The only difference is that the pipe 104 in the joint section 106 is furthermore configured with a stop shoulder 124, which is to be used as an assembly aid when tightening the treaded pipe joint 100. The end of the assembly process is indicated to the technician through a significant torque rise. The stop shoulder 124 is disposed on the side of the retaining bead 117 facing the threaded body 103 and is comprised of a radially extending stop surface of the pipe 104. The outer enveloping surface of the joint section 106 has a cylindrical section 126 between the 45° retaining cone 118 and the stop shoulder 124.

In FIG. 5 the components are not in operating condition yet, and the stop shoulder 124 does not contact the radial face 109 of the threaded body 103 yet. The joint section 106 is supported only in operating condition with its stop shoulder 124 at the face 109 of the threaded body 103.

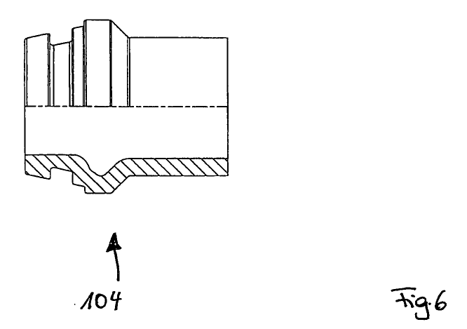

FIG. 6 shows the alternatively configured pipe 104 of FIG. 4 separately again.

REFERENCE NUMERALS AND DESIGNATIONS

| | |
|---|---|
| 1 | Pipe joint |
| 2 | Center axis |
| 3 | Threaded connecting body |
| 4 | Pipe |
| 5 | Non deformed section |
| 6 | Joint section |
| 7 | Coupling nut |
| 8 | 24° receiving cone |
| 9 | Face |
| 10 | Section parallel to axis |
| 11 | Pipe seat base |
| 12 | Threaded section |
| 13 | Threaded section |
| 14 | 45° clamping cone |
| 15, 15′ | Hexagonal surface |
| 16 | End section |
| 17 | Retaining bead |
| 18 | 45° Retaining cone |
| 19 | 24° Centering cone |
| 20 | Face |
| 21 | Circumferential groove |
| 22 | Recess |
| 23 | Step |
| 100 | Pipe joint |
| 102 | Center axis |
| 103 | Threaded connecting body |
| 104 | Pipe |
| 105 | Non deformed section |
| 106 | Joint section |
| 109 | Radial face |
| 117 | Retaining bead |
| 118 | 45° Retaining cone |
| 119 | 24° centering cone |
| 124 | Stop Shoulder |
| 125 | Stop surface |
| 126 | Cylindrical section |

What is claimed is:

1. A pipe joint comprising a pipe, a threaded connecting body and a coupling nut, wherein the threaded connecting body comprises a bore hole starting at a radial face and provided with a 24° receiving cone and a section parallel to an axis and connected to the receiving cone, which section transitions into a radially extending pipe seat base and is provided at its outer enveloping surface with a first threaded section, which interacts with a second threaded section at an inner enveloping surface of a pass through bore hole of the coupling nut, which is provided with a 45° clamping cone, which interacts with a 45° retaining cone at an outer enveloping surface of the pipe, wherein the pipe comprises a joint section, which is disposed in an assembled state of the pipe joint in the bore hole of the threaded connecting body and also in the pass through bore hole of the coupling nut, and wherein the pipe also comprises a non deformed section in which the pipe is in its original state, wherein the joint section comprises a retaining bead extending over the outer diameter of the pipe in the non deformed section radially outward, which retaining bead comprises the 45° retaining cone and a 24° centering cone which is inclined in an opposite direction and also disposed at the retaining bead, which centering cone interacts in the assembled state of the pipe joint with the 24° receiver cone of the threaded connecting body, wherein a circumferential groove for receiving an elastomeric seal ring is provided in the 24° centering cone, wherein the joint section of the pipe is integrally connected with the non-deformed section of the pipe and produced through a plastic deformation process, in particular a crushing process caused in axial direction of the pipe.

2. A pipe joint according to claim 1, wherein the circumferential groove comprises a parallelogram shaped cross section and two walls extending in parallel to one another and orthogonal to the longitudinal axis of the pipe, and a groove base extending in parallel to the 24° centering cone.

3. A pipe joint according to claim 1, wherein the 24° centering cone extends to a face of the pipe.

4. A pipe joint according to claim 1, wherein an inner enveloping surface of the pipe is provided with a radially outward extending circumferential recess in the joint section.

5. A pipe joint according to claim 1, wherein a stop shoulder with a radially oriented stop surface facing the 24° centering cone is disposed between the 45° retaining cone and the 24° centering cone, wherein a section of the outer enveloping surface of the joint portion with a cylindrical enveloping surface is connected to the radially oriented stop surface in a direction towards the 45° retaining cone.

6. A pipe joint according to claim 1, wherein the plastic deformation process is a multistep crushing process which uses multiple tools.

7. A method for producing a joint section of a pipe joint, comprising a pipe, a threaded connecting body and a coupling nut, wherein the threaded connecting body comprises a bore hole starting at a radial face and provided with a 24° receiving cone and a section parallel to an axis and connected to the receiving cone, which section transitions into a radially extending pipe seat base and is provided at its outer enveloping surface with a first threaded section, which interacts with a second threaded section at an inner enveloping surface of a pass through bore hole of the coupling nut, which is provided with a 45° clamping cone, which interacts with a 45° retaining cone at an outer enveloping surface of the pipe, wherein the pipe comprises a joint section, which is disposed in an assembled state of the pipe joint in the bore hole of the threaded connecting body and also in the pass through bore hole of the coupling nut, and wherein the pipe also comprises a non deformed section in which the pipe is in its original state, wherein the joint section comprises a retaining bead extending over the outer diameter of the pipe in the non deformed section radially outward, which retaining bead comprises a 45° retaining cone and a 24° centering cone which is inclined in an opposite direction and also disposed at the retaining bead, which centering cone interacts in the assembled state of the pipe joint with the 24° receiver cone of the threaded connecting body, wherein a circumferential groove for receiving an elastomeric seal ring is provided in the 24° centering cone, wherein the joint section is produced through a plastic deformation process from a prior end section of the non-deformed section.

8. A method according to claim 7, wherein the circumferential groove is produced with a parallelogram shaped cross section and comprises two walls extending in parallel to one another and orthogonal to the longitudinal axis of the pipe and a groove base extending in parallel to the 24° centering cone.

9. A method according to claim 7, wherein the 24° centering cone is configured so it extends to a face of the pipe.

10. A method according to claim 7, wherein the joint section is produced by a crushing process using a press and associated forming tools.

11. A method according to claim 7, wherein the joint section is produced through a multistep crushing process, in particular a crushing process with at least five sequential steps, wherein a progressing approximation of a final contour of the joint section is achieved in each step.

12. A method according to claim 8, wherein the 24° centering cone is configured so it extends to a face of the pipe.

13. A method according to claim 8, wherein the joint section is produced by a crushing process using a press and associated forming tools.

14. A method according to claim 9, wherein the joint section is produced by a crushing process using a press and associated forming tools.

15. A method according to claim 8, wherein the joint section is produced through a multistep crushing process, in particular a crushing process with at least five sequential steps, wherein a progressing approximation of a final contour of the joint section is achieved in each step.

16. A pipe joint according to claim 2, wherein the 24° centering cone extends to a face of the pipe.

17. A pipe joint according to claim 2, wherein an inner enveloping surface of the pipe is provided with a radially outward extending circumferential recess in the joint section.

18. A pipe joint according to claim 3, wherein an inner enveloping surface of the pipe is provided with a radially outward extending circumferential recess in the joint section.

19. A pipe joint according to claim 2, wherein a stop shoulder with a radially oriented stop surface facing the 24° centering cone is disposed between the 45° retaining cone and the 24° centering cone, wherein a section of the outer enveloping surface of the joint portion with a cylindrical enveloping surface is connected to the radially oriented stop surface in a direction towards the 45° retaining cone.

20. A pipe joint according to claim 3, wherein a stop shoulder with a radially oriented stop surface facing the 24° centering cone is disposed between the 45° retaining cone and the 24° centering cone, wherein a section of the outer enveloping surface of the joint portion with a cylindrical enveloping surface is connected to the radially oriented stop surface in a direction towards the 45° retaining cone.
